(19) United States
(12) Patent Application Publication
(10) Pub. No.: US 2010/0054099 A1
(43) Pub. Date: Mar. 4, 2010

(54) Optical Disc Apparatus and Focus Offset Setting Method Thereof

(75) Inventors: Mayumi SASAKI, Fujisawa (JP); Tsuyoshi Toda, Kodaira (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 12/430,187

(22) Filed: Apr. 27, 2009

(30) Foreign Application Priority Data
Aug. 29, 2008 (JP) 2008-221867

(51) Int. Cl. G11B 7/125

(52) U.S. Cl. 369/53.28; G9B/7.098

(57) ABSTRACT

An optical disc apparatus in which, regarding mutually adjacent recording layers, a focus offset of an optical system to a guide groove formed in a recording surface of the recording layer is learned based on a signal based on reflected light from the guide groove, and a focus offset for recording or reproduction is calculated and set based on the learned focus offsets for the respective recording layers. As the focus offset of the optical system for recording or reproduction, a mean value of the learned focus offsets for the respective recording layers is set as a focus offset common to the both recording layers. Otherwise, a focus offset when a difference between the focus offset and the learned focus offsets for the respective recording layers is a value corresponding to a characteristic of the optical system is set. This structure reduces processing time and ensures processing precision upon focus offset processing for plural recording layers.

### CLAIM OF PRIORITY

The present application claims priority from Japanese patent application serial No. P2008-221867, filed on Aug. 29, 2008, the content of which is hereby incorporated by reference into this application.

### BACKGROUND

1. Technical Field

The present invention relates to focus offset processing in an optical disc apparatus, and more particularly, when an optical disc has plural recording layers, to focus offset setting for the plural recording layers.

2. Description of the Related Art

Known related arts are disclosed in e.g. Japanese Patent No. 3465413, Japanese Published Unexamined Patent Applications Nos. 2003-217140 and 2003-248940. Japanese Patent No. 3465413 discloses a technique of setting a focus offset value using a tracking error signal amplitude, jitter, an RF signal amplitude and the like. Japanese Published Unexamined Patent Application No. 2003-217140 discloses a technique of independently setting a focus offset for respective recording layers. Japanese Published Unexamined Patent Application No. 2003-248940 discloses a technique of providing a temperature detector in an apparatus, and when an apparatus inner temperature changes to or beyond a predetermined value and focus jump, seek or the like has been completed, performing offset re-adjustment.

### SUMMARY

In the above-described related techniques, since focus offset amounts for respective recording layers are independently obtained or a focus offset amount after recording layer change is obtained based on differences in tracking error signal amplitude, jitter, an RF signal amplitude and the like between statuses before and after the recording layer change, time required for offset processing is long. Further, in the case of an unrecorded state recording layer, processing precision may not be ensured.

The present invention has a problem towards, in an optical disc apparatus, upon focus offset processing for plural recording layers, reducing processing time and ensuring processing precision for a recorded state recording layer (including a reproduction-only disc) and an unrecorded state recording layer.

Further, the present invention has an object to provide a technique for improvement of usability in an optical disc apparatus.

The present invention provides a technique to solve the problem and achieve the object.

That is, according to the present invention, in an optical disc apparatus, regarding mutually adjacent respective recording layers among plural recording layers of an optical disc, a focus offset of an optical system to a guide groove formed on a recording surface of the recording layer is learned from a signal based on reflected light from the guide groove. Then, based on the learned focus offsets for the respective recording layers, a focus offset for recording or reproduction is calculated and set. As a focus offset of the optical system for recording or reproduction, a mean value of the learned focus offsets for the respective recording layers is set as a common focus offset to the both recording layers, otherwise, a focus offset when a difference between the focus offset and the learned focus offsets for the respective recording layers is a value corresponding to the characteristic of the optical system is set.

Note that in the present invention, the focus offset obtained by the above-described learning means a focus offset within an appropriate range in the present invention. Further, the “recording layer” in the present invention means a layer in which information is recorded (recording layer), and includes a recording layer in which information is already recorded (including a recording layer of a reproduction-only disc and a recording layer of recordable disc i.e. a rewritable or write-once-read-many disc) and a recording layer in which information is not recorded yet but will be recorded (in this case, a recording layer of a recordable disc).

### BRIEF DESCRIPTION OF THE DRAWINGS

FIG. 1 is a block diagram of an optical disc apparatus in an embodiment;

FIG. 2 illustrates positions of reference surfaces of plural recording layers of an optical disc and positions of an optical system in an optical pickup, in the optical disc apparatus in FIG. 1;

FIG. 3 is a graph explaining focus offset learning and focus offset setting for recording or reproduction in the optical disc apparatus in FIG. 1;

FIG. 4 is a graph explaining the focus offset learning and the focus offset setting for recording or reproduction in the optical disc apparatus in FIG. 1 based on measured data;

FIG. 5 is a graph explaining the focus offset learning and the focus offset setting for recording or reproduction in the optical disc apparatus in FIG. 1 based on other measured data; and

FIG. 6 is a flowchart showing the operation of focus offset processing by the optical disc apparatus in FIG. 1 for adjacent recording layers in the optical disc.

### DETAILED DESCRIPTION OF THE PREFERRED EMBODIMENT

Hereinbelow, an embodiment will be described in accordance with the drawings.

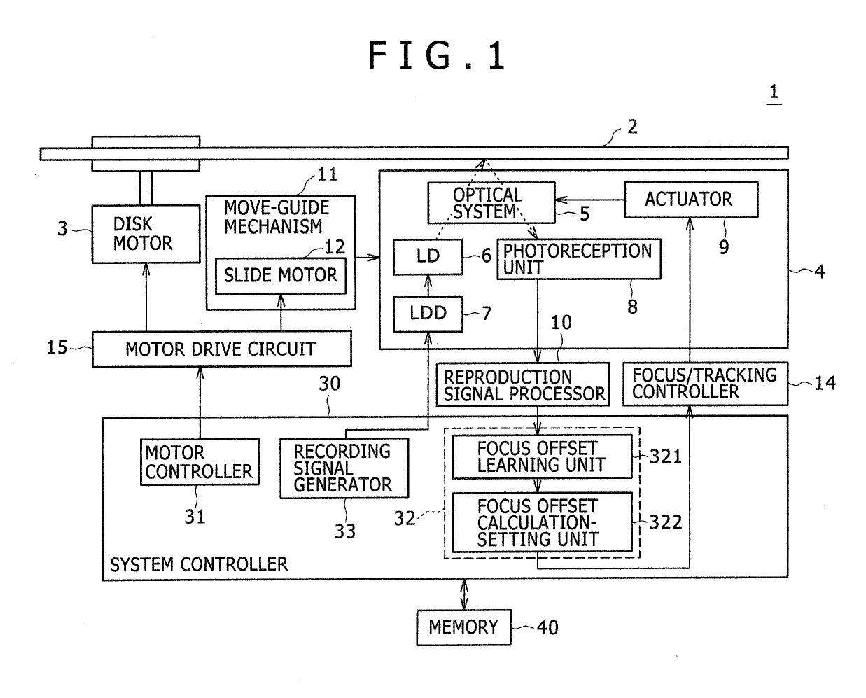

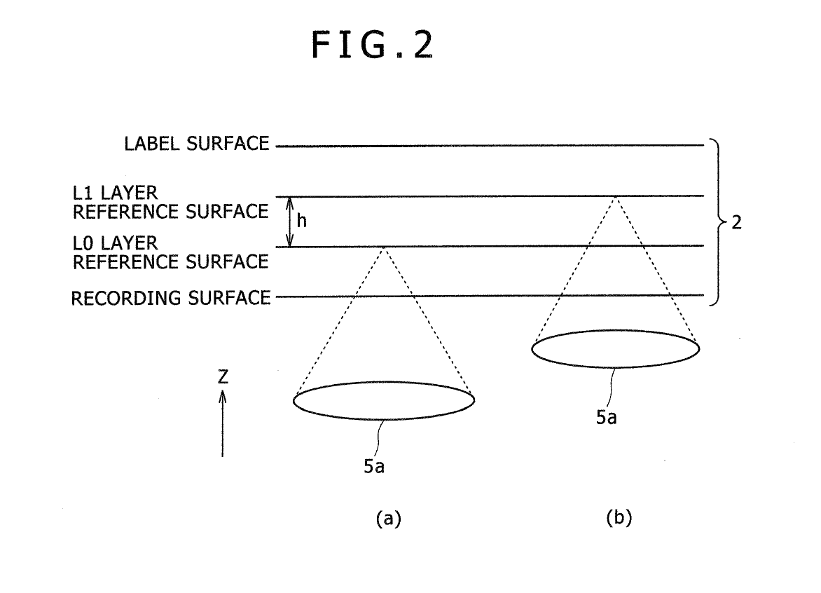

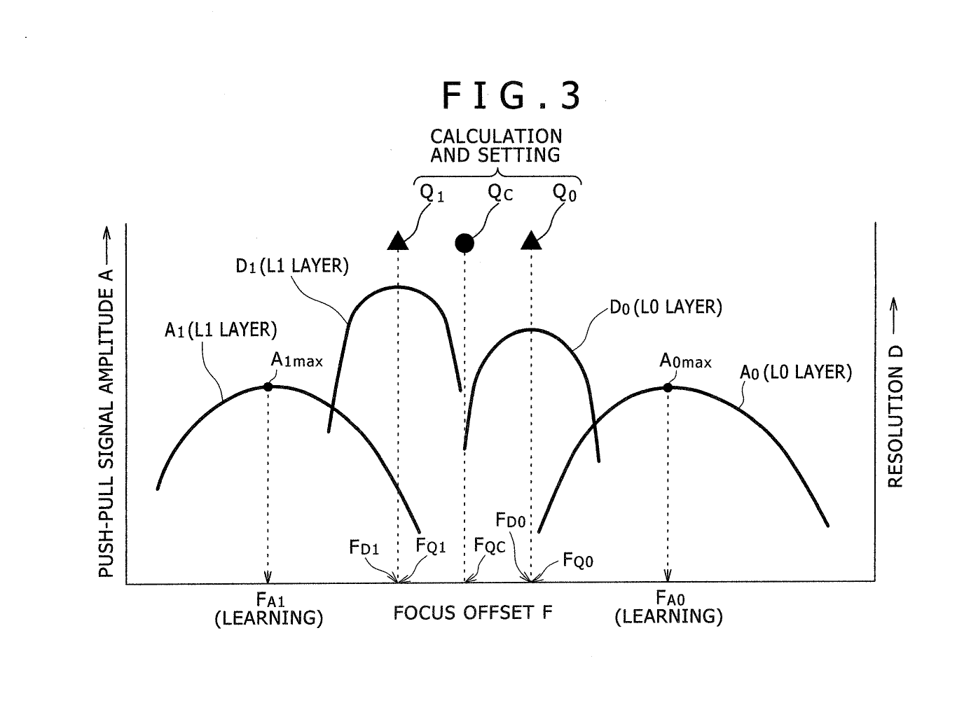

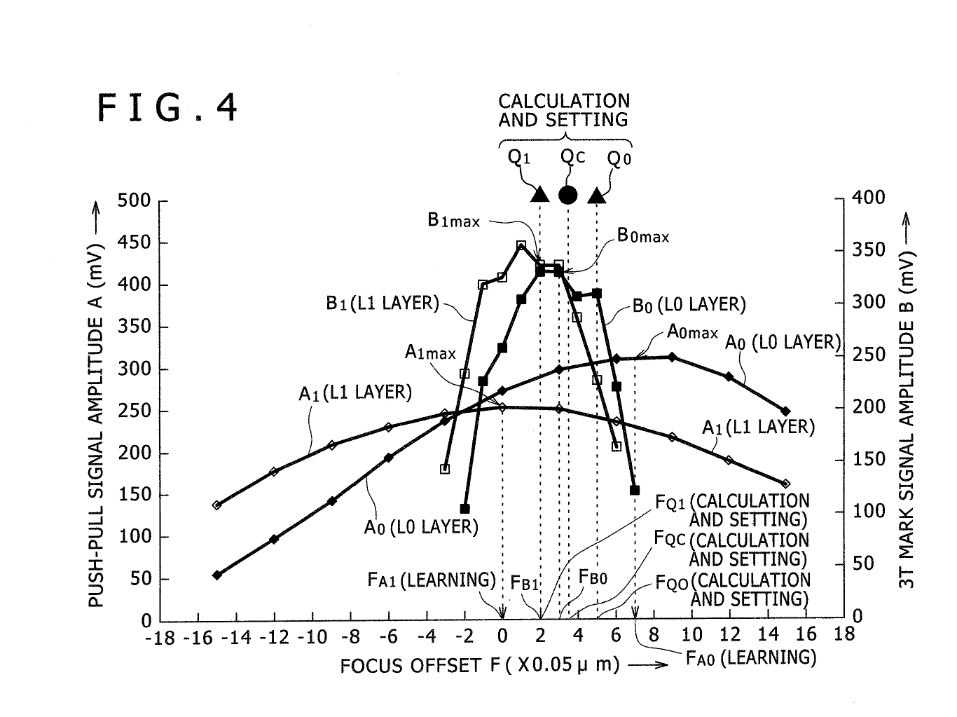

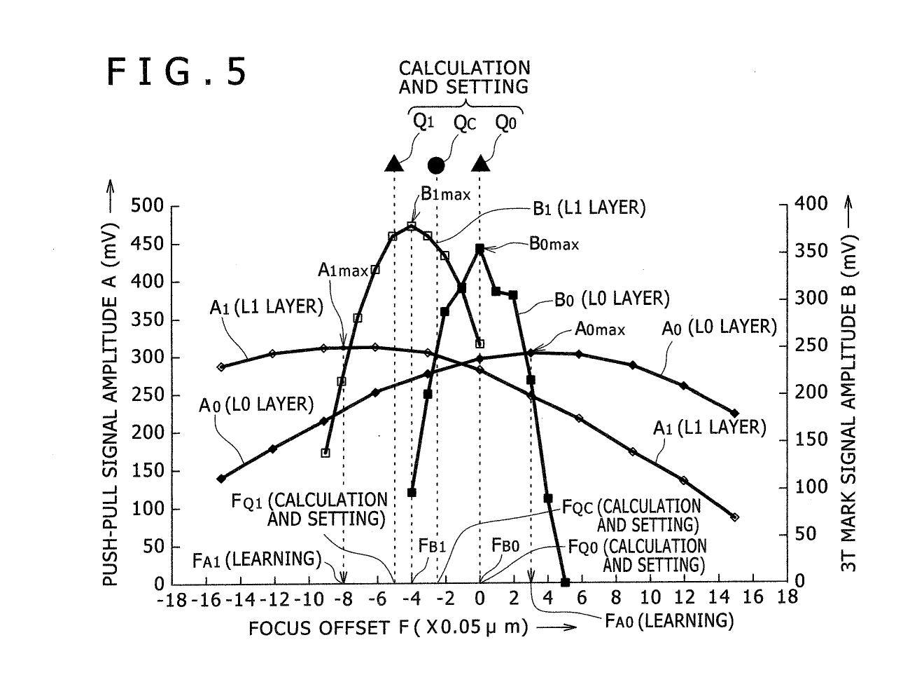

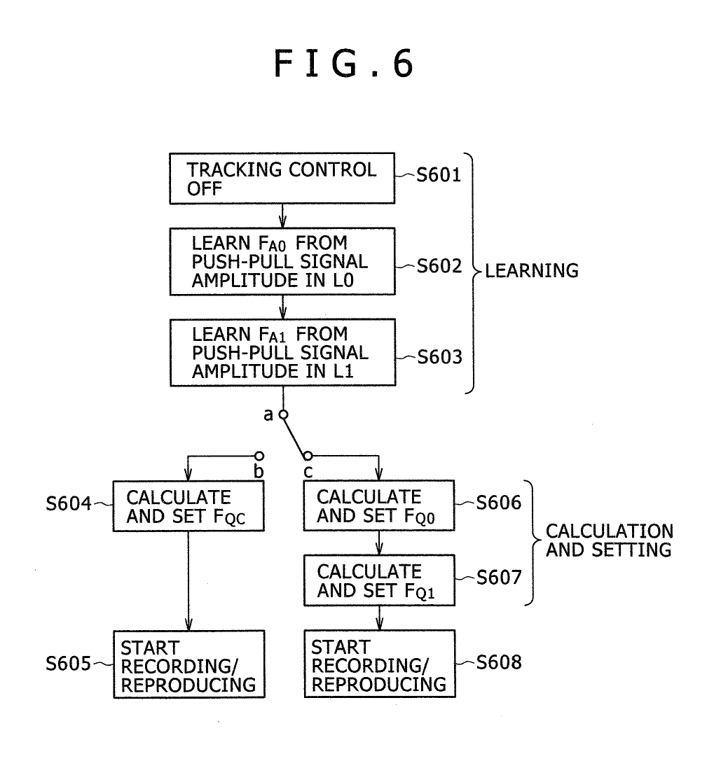

FIGS. 1 to 6 are explanatory views of an optical disc apparatus in the embodiment. FIG. 1 is a block diagram of an optical disc apparatus in an embodiment; FIG. 2 illustrates positions of reference surfaces of plural recording layers of an optical disc and positions of an optical system in an optical pickup, in the optical disc apparatus in FIG. 1; FIG. 3 is a graph explaining focus offset learning and focus offset setting for recording or reproduction in the optical disc apparatus in FIG. 1; FIG. 4 is a graph explaining the focus offset learning and the focus offset setting for recording or reproduction in the optical disc apparatus in FIG. 1 based on measured data; FIG. 5 is a graph explaining the focus offset learning and the focus offset setting for recording or reproduction in the optical disc apparatus in FIG. 1 based on other measured data; and FIG. 6 is a flowchart showing the operation of focus offset processing by the optical disc apparatus in FIG. 1 for adjacent recording layers in the optical disc.

Note that the “recording layer” used in the following description means a layer in which information is recorded (recording layer), and includes a recording layer in which information is already recorded (including a recording layer of a reproduction-only disc and a recording layer of recordable disc) and a recording layer in which information is not recorded yet but will be recorded (in this case, a recording layer of a recordable disc).

In FIG. 1, reference numeral 1 denotes an optical disc apparatus in the embodiment; 2 denotes an optical disc such as a DVD±R DL having plural recording layers; 3 denotes a disc motor to rotate-drive the optical disc 2; 4 denotes an optical pickup; 5 denotes an optical system including an objective lens (not shown), provided in the optical pickup 4, to collect a laser beam and emit the collected laser beam on a recording surface of the optical disc 2; 6 denotes a laser diode provided in the optical pickup 4, to generate a laser beam in predetermined intensity for recording or reproduction; 7 denotes a laser drive circuit provided in the optical pickup 4, to drive the laser diode 6; 8 denotes a photoreception unit (photodetector) provided in the optical pickup 4, to receive reflected light from the recording surface (disc surface) of the optical disc 2 via the optical system 5, convert the received light into an electric signal (reproduction signal) and output the signal; 9 denotes an actuator to change the position and attitude of the objective lens (not shown) in the optical system 5; 10 denotes a reproduction signal processor to perform signal processing on the reproduction signal outputted from the photoreception unit 8, as an RF signal, by performing amplification, demodulation and the like; 11 denotes move-guide mechanism having a linear guide member (not shown), a lead screw member (not shown) and the like to move the optical pickup 4 in an approximately radial direction of the optical disc 2; 12 denotes a slide motor provided in the move-guide mechanism 11, to rotate-drive the lead screw member (not shown); 14 denotes a focus/tracking controller to generate a drive signal to drive the actuator 9; 15 denotes a motor drive circuit to rotate-drive the disc motor 3 and the slide motor 12; 30 denotes a system controller as a controller to control the entire optical disc apparatus 1; 31 denotes a motor controller provided in the system controller 30, to control the motor drive circuit 15; 32 denotes a microcomputer in the system controller 30; 321 denotes a focus offset learning unit as a first controller provided in the microcomputer 32, to learn (detect) an optimum focus offset (focus offset within an optimum range i.e. a focus offset within an appropriate range in the present invention. In the following description, the “optimum focus offset” always means this focus offset) of the optical system 5 from a signal outputted from the reproduction signal processor 10; and 322 denotes a focus offset calculation-setting unit as a second controller provided in the microcomputer 32, to calculate and set a focus offset of the optical system 5 for recording or reproduction based on the optimum focus offset learned by the focus offset learning unit 321. Upon learning of the optimum focus offset, based on the signal outputted from the reproduction signal processor 10, i.e., a signal based on reflected light from a guide groove formed in respective recording surfaces of mutually adjacent recording layers among plural recording layers of the optical disc 2, the focus offset learning unit 321 as the first controller learns (detects) the optimum focus offset of the optical system 5 to respective guide grooves.

Further, in FIG. 1, numeral 33 denotes a recording signal generator to generate and output a recording signal to drive the laser diode 6; and 40 denotes a memory holding characteristic information of the optical system 5, information on the optimum focus offset for both adjacent recording layers learned by the focus offset learning unit 321, information on the focus offset of the optical system 5 for recording or reproduction calculated and set by the focus offset calculation-setting unit 322, a program to cause the focus offset learning unit 321 to execute a series of procedures of learning operation, a program to cause the focus offset calculation-setting unit 322 to execute a series of procedures of calculation-setting operation, and the like. The characteristic information of the optical system 5, the program for execution of the learning operation, and the program for execution of the calculation and setting operation are previously stored in the memory 40 prior to the optimum focus offset learning operation by the focus offset learning unit 321.

Upon the optical focus offset learning, as a signal based on the reflected light from the guide groove formed in the recording surfaces of mutually adjacent plural recording layers, a push-pull signal or a wobble signal is outputted from the reproduction signal processor 10.

Upon optimum focus offset learning, the focus offset learning unit 321 as the first controller uses the push-pull signal or the wobble signal outputted from the reproduction signal processor 10, and learns (detects) focus offsets when the amplitude of the push-pull signal or the wobble signal is maximum (a value within a substantially maximum range, i.e., a value within a range including a true maximum value and e.g. 95% of the true maximum value. Hereinbelow, “maximum” or “maximum value” in the amplitude of the push-pull signal or the wobble signal has this meaning) as respective optimum focus offsets to the respective guide grooves of the mutually adjacent plural recording layers. When the optimum focus offset is learned from the push-pull signal, tracking control is turned off (OFF). When the optimum focus offset is learned from the wobble signal, the tracking control is turned on (ON). The focus offset learning unit 321 performs predetermined procedures in the optimum focus offset learning operation in accordance with the program read from the memory 40.

When the focus offset calculation-setting unit 322 as the second controller calculates and sets a focus offset for information recording or reproduction on/from mutually adjacent plural recording layers, the focus offset calculation-setting unit 322 calculates a mean value of respective optimum focus offsets of the adjacent plural recording layers i.e. focus offsets when the amplitude of the above-described push-pull signal or the wobble signal is maximum (mean focus offset), learned by the focus offset learning unit 321, and sets the calculated mean value as a common focus offset to the both recording layers upon recording or reproduction. Otherwise, the focus offset calculation-setting unit 322 calculates a focus offset when the difference between the focus offset and the optimum focus offsets of the respective recording layers learned by the focus offset learning unit 321 is a value corresponding to the characteristic of the optical system 5 i.e. a focus offset weighted by recording layer in correspondence with the characteristic of the optical system 5, and individually sets the calculated focus offset by recording layer as a focus offset for recording or reproduction in the above-described mutually adjacent plural recording layers.

When the above-described mean focus offset for recording or reproduction is calculated and set using the result of learning by the focus offset learning unit 321, the focus offset calculation-setting unit 322 sets the focus offset as follows. That is, for example, when a first recording layer (L0 layer) and a second recording layer (L1 layer) are arranged from the laser beam incident side (the side on which the optical system 5 is provided), and F_{A0} is obtained as a focus offset when the amplitude of the push-pull signal or the wobble signal is maximum by learning by the focus offset learning unit 321 with respect to the first recording layer (L0 layer) and F_{A1} is obtained as a focus offset when the amplitude of the push-pull signal or the wobble signal is maximum by learning with respect to the second recording layer (L1 layer), a value as focus offset F_{QC} for recording or reproduction in the first recording layer (L0 layer) and the second recording layer (L1 layer), calculated by, e.g.,

F_{QC}=(F_{A0}+F_{A1})/2 (Expression 1)

is set as a common focus offset (focus offset for recording or reproduction) to the first recording layer (L0 layer) and the second recording layer (L1 layer).

Further, when a focus offset for recording or reproduction is calculated and set individually for the adjacent recording layers using the result of learning by the focus offset learning unit 321 and in correspondence with the characteristic of the optical system 5, the focus offset calculation-setting unit 322 sets the focus offset as follows. That is, for example, when a first recording layer (L0 layer) and a second recording layer (L1 layer) are arranged from the laser beam incident side, and F_{A0} is obtained as a focus offset when the amplitude of the push-pull signal or the wobble signal is maximum by learning by the focus offset learning unit 321 with respect to the first recording layer (L0 layer) and F_{A1} is obtained as a focus offset when the amplitude of the push-pull signal or the wobble signal is maximum by learning with respect to the second recording layer (L1 layer), a value as focus offset F_{Q0} for recording or reproduction in the first recording layer (L0 layer) calculated by, e.g.,

F_{Q0}=(3×F_{A0}+F_{A1})/4 (Expression 2)

is set.

Further, as focus offset F_{Q1} for recording or reproduction in the second recording layer (L1 layer), a value calculated by, e.g.,

F_{Q1}=(F_{A0}+3×F_{A1})/4 (Expression 3)

is set.

The focus offset calculation-setting unit 322 performs the operation procedures to calculate and set the above-described focus offset of the optical system 5 for recording or reproduction in accordance with the program read from the memory 40.

Note that the above-described expressions 1 to 3 are expressions obtained by an experiment using plural optical discs by the present inventor in the progress of study of the present invention, and are practical expressions to solve the problems of the present invention and obtain remarkable effects.

In the optical disc apparatus 1 having the above-described configuration, upon information recording or reproduction with respect to the optical disc 2 having plural recording layers, e.g. in a status where, the optical disc 2 is loaded in the apparatus and rotated at a predetermined speed, a laser beam generated by the laser diode 6 in the optical pickup 4 is emitted on recording surfaces of the plural recording layers of the optical disc 2 through the optical system 5, and focus offset processing for the plural recording layers is performed. The focus offset processing is performed by utilizing groove information on a guide groove (structure and status of the groove) formed in the respective recording layers, for mutually adjacent recording layers. That is, regarding the mutually adjacent recording layers, reflected light from the guide groove formed in the recording surface of the recording layer is received by the photoreception unit 8 then converted to an electric signal (reproduction signal), and outputted from the reproduction signal processor 10 as a push-pull signal or a wobble signal. When it is arranged such that a push-pull signal is outputted from the reproduction signal processor 10 upon focus offset processing, the tracking control is not performed in the optical disc apparatus 1, and only a focus control signal is outputted from the focus/tracking controller 14. On the other hand, when it is arranged such that a wobble signal is outputted from the reproduction signal processor 10, the tracking control is also performed, and focus control signal and tracking control signal are outputted from the focus/tracking controller 14. The push-pull signal or the wobble signal outputted from the reproduction signal processor 10 as groove information on the guide groove of the mutually adjacent respective recording layers is inputted into the focus offset learning unit 321 in the microcomputer 32. The focus offset learning unit 321 learns (detects) a focus offset when the amplitude of the inputted push-pull signal or wobble signal is maximum as an optimum focus offset, for the mutually adjacent respective recording layers. The focus offset calculation-setting unit 322 in the microcomputer 32 calculates a mean value of the optimum focus offsets for the mutually adjacent recording layers learned by the focus offset learning unit 321 or a focus offset when the difference between the focus offset and the learned respective optimum focus offsets is a value corresponding to the characteristic of the optical system 5, as described above, and sets the calculated focus offset as a focus offset of the above-described optical system for recording or reproduction.

Hereinbelow, the constituent elements of the optical disc apparatus 1 in FIG. 1 used in the following description have the same reference numerals in FIG. 1.

FIG. 2 illustrates positions of reference surface (surface where the focus offset is 0 (zero)) of plural recording layers of the optical disc 2 and corresponding positions of the optical system 5 in the optical pickup 4 in the optical disc apparatus 1 in FIG. 1. FIG. 2(a) shows a status where a laser beam collected with the optical system 5 is emitted on the first recording layer (L0 layer) and learning of an optimum focus offset for the first recording layer (L0 layer) is performed from a push-pull signal or a wobble signal based on reflected light from the guide groove of the recording surface of the first recording layer (L0). FIG. 2(b) shows a status where the laser beam collected with the optical system 5 is emitted on the second recording layer (L1 layer) adjacent to the above-described first recording layer (L0 layer) and learning of an optimum focus offset for the second recording layer (L1 layer) is performed from a push-pull signal or a wobble signal based on reflected light from the guide groove of the recording surface of the second recording layer (L1). Numeral 5a denotes an objective lens in the optical system 5, and h denotes a distance between the reference surface of the first recording layer (L0 layer) and the reference surface of the second recording layer (L1 layer). Upon learning of an optimum focus offset, the position of the objective lens 5a in a focus direction (±Z axis direction) is controlled by the actuator 9 based on the focus control signal from the focus/tracking controller 14. When learning of an optimum focus offset for the first recording layer (L0 layer) is performed, the position of the objective lens 5a in the focus direction is changed by the actuator 9 in the vicinity of the reference surface of the first recording layer (L0 layer) including the reference surface position of the first recording layer (L0 layer), and a focus offset by the objective lens 5a in the position in the focus direction when the amplitude of the push-pull signal or the wobble signal is maximum is learned by the focus offset learning unit 321 as an optimum focus offset for the first recording layer (L0 layer). Similarly, when learning of an optimum focus offset for the second recording layer (L1 layer) is performed, the position of the objective lens 5a in the focus direction is changed by the actuator 9 in the vicinity of the reference surface of the second recording layer (L1 layer) including the reference surface position of the second recording layer (L1 layer), and a focus offset by the objective lens 5a in the position in the focus direction when the amplitude of the push-pull signal or the wobble signal is maximum is learned by the focus offset learning unit 321 as an optimum focus offset for the second recording layer (L1 layer).

In the following explanation, the first recording layer (L0 layer) and the second recording layer (L1 layer) are in the positional relation shown in the FIG. 2 with respect to the laser beam incident direction (direction in which the objective lens 5a is provided).

FIG. 3 is a graph explaining focus offset learning and focus offset setting for recording or reproduction with respect to the optical disc 2 in the optical disc apparatus 1 in FIG. 1. In FIG. 3, the focus offset learning is performed using a push-pull signal. In FIG. 3, a horizontal axis indicates focus offset F, and a vertical axis, a push-pull signal amplitude A and a resolution D.

In FIG. 3, reference numeral A₀ denotes a model of an amplitude characteristic curve of the push-pull signal outputted from the reproduction signal processor 10 based on reflected light from the guide groove of the first recording layer (L0 layer); A₀ₘₐₓ denotes a maximum value on the amplitude characteristic curve A₀ i. e. a maximum value of the push-pull signal amplitude regarding the first recording layer (L0 layer); F_{A0} denotes a focus offset when the push-pull signal amplitude is the maximum value A₀ₘₐₓ on the amplitude characteristic curve A₀ i.e. an optimum focus offset; A₁ denotes a model of an amplitude characteristic curve of the push-pull signal outputted from the reproduction signal processor 10 based on reflected light from the guide groove of the second recording layer (L1 layer); A₁ₘₐₓ denotes a maximum value on the amplitude characteristic curve A₁ i.e. a maximum value of the push-pull signal amplitude regarding the second recording layer (L1 layer); F_{A1} denotes a focus offset when the push-pull signal amplitude is the maximum value A₁ₘₐₓ on the amplitude characteristic curve A₁ i.e. an optimum focus offset; D₀ denotes a model of a resolution characteristic curve based on the reflected light from the first recording layer (L0 layer); F_{D0} denotes a focus offset when the resolution characteristic curve D₀ is a maximum value; D₁ denotes a model of a resolution characteristic curve based on the reflected light from the second recording layer (L1 layer); and F_{D1} denotes a focus offset when the resolution characteristic curve D₁ is a maximum value. The above-described maximum value A₀ₘₐₓ of the push-pull signal amplitude and the focus offset F_{A0} at that time (optimum focus offset) and above-described maximum value A₁ₘₐₓ of the push-pull signal amplitude and the focus offset F_{A1} at that time (optimum focus offset) are learned (detected) by the focus offset learning unit 321 as the first controller. Note that the above-described resolution D is defined with a ratio between the amplitude of the signal based on the reflected light from a shortest mark (3T mark in a DVD) in the guide groove in the respective recording layers of the optical disc 2 to the amplitude of the signal based on the reflected light from a longest mark (11T mark in a DVD) in the guide groove in the respective recording layers of the optical disc 2.

Further, in FIG. 3, numeral Q₀ denotes a position of a focus offset calculated and set by the focus offset calculation-setting unit 322 based on the above-described focus offsets (optimum focus offsets) F_{A0} and F_{A1} such that the difference between the focus offset and the focus offset F_{A0} is a value corresponding to the characteristic of the optical system 5, i.e., a position of a focus offset weighted to the focus offset F_{A0} side in correspondence with the characteristic of the optical system 5; F_{Q0} denotes a focus offset corresponding to the position Q₀; Q₁ denotes a position of a focus offset calculated and set by the focus offset calculation-setting unit 322 based on the above-described focus offsets F_{A0} and F_{A1} such that the difference between the focus offset and the focus offset F_{A1} is a value corresponding to the characteristic of the optical system 5, i.e., a position of a focus offset weighted to the focus offset F_{A1} side in correspondence with the characteristic of the optical system 5; F_{Q1} denotes a focus offset corresponding to the position Q₁; Q_{C} denotes a position of a focus offset calculated and set by the focus offset calculation setting unit 322 based on the above-described focus offsets F_{A0} and F_{A1} as a mean value focus offset of the both focus offsets F_{A0} and F_{A1}; and F_{QC} denotes a focus offset corresponding to the position Q_{C}. FIG. 3 shows a case where the precision of an expression used in focus offset calculation by the focus offset calculation-setting unit 322 is high, the focus offset F_{Q0} calculated and set by the focus offset calculation-setting unit 322 and the focus offset F_{D0} when the resolution characteristic curve D₀ is a maximum value are the same, and the focus offset F_{Q1} calculated and set by the focus offset calculation-setting unit 322 and the focus offset F_{D1} when the resolution characteristic curve D₁ is a maximum value are the same. The focus offset F_{QC} is calculated by using e.g. the expression 1, the focus offset F_{Q0} is calculated by using e.g. the expression 2, and the focus offset F_{Q1} is calculated by using e.g. the expression 3. The respective focus offsets F_{QC}, F_{Q0} and F_{Q1} are set as focus offsets for information recording or reproduction without obtaining the resolution characteristic curves D₀, D₁ and the focus offsets F_{D0} and F_{D1}.

Note that on the horizontal axis in FIG. 3, the position of the focus offset F=0 in the first recording layer (L0 layer) and the position of the focus offset F=0 in the second recording layer (L1 layer) are overlapped each other. That is, in FIG. 3, the above-described both positions are overlapped each other assuming that the distance h in FIG. 2 is 0 (zero).

FIG. 4 is a graph explaining the focus offset learning and the focus offset setting for information recording or reproduction in the optical disc apparatus in FIG. 1 based on measured data, in which a horizontal axis indicates the focus offset F, and a vertical axis, the push-pull signal amplitude A and amplitude B of the signal regarding the 3T mark. In FIG. 4, the result of learning using the push-pull signal by the focus offset learning unit 321 is used. The focus offset calculation-setting unit 322 calculates a mean value of optimum focus offsets obtained by the learning (focus offsets within optimum ranges i.e. focus offsets within appropriate ranges in the present invention), and sets the calculated focus offset as a focus offset for recording or reproduction. Further, the focus offset calculation-setting unit 322 obtains a focus offset when the difference between the focus offset and the optimum focus offsets obtained by the above-described learning is a value corresponding to the characteristic of the optical system 5 i.e. a focus offset weighted in correspondence with the characteristic of the optical system 5, by calculation, and sets the obtained focus offset as a focus offset for recording or reproduction.

In FIG. 4, numeral A₀ denotes a measured amplitude characteristic curve of the push-pull signal outputted from the reproduction signal processor 10 based on reflected light from the guide groove of the first recording layer (L0 layer); A₀ₘₐₓ denotes an amplitude value learned by the focus offset learning unit 321 as a maximum value on the measured amplitude characteristic curve A₀ i.e. a maximum value (a maximum value obtained by polynomial expression using measured data) of the push-pull signal amplitude regarding the first recording layer (L0 layer); F_{A0} denotes a focus offset learned by the focus offset learning unit 321 as a focus offset when the push-pull signal amplitude is maximum on the measured amplitude characteristic curve A₀ i.e. an optimum focus offset. Further, numeral A₁ denotes a measured amplitude characteristic curve of the push-pull signal outputted from the reproduction signal processor 10 based on reflected light from the guide groove of the second recording layer (L1 layer); A₁ₘₐₓ denotes an amplitude value learned by the focus offset learning unit 321 as a maximum value on the measured amplitude characteristic curve A₁ i.e. a maximum value (a maximum value obtained by polynomial expression using measured data) of the push-pull signal amplitude regarding the second recording layer (L1 layer); and F_{A1} denotes a focus offset learned by the focus offset learning unit 321 as a focus offset when the push-pull signal amplitude is maximum on the measured amplitude characteristic curve A₁ i.e. an optimum focus offset.

Further, in FIG. 4, numeral B₀ denotes a measured amplitude characteristic curve of a signal outputted from the reproduction signal processor 10 based on reflected light from the 3T mark in the guide groove of the first recording layer (L0 layer); F_{B0} denotes a focus offset when the measured amplitude characteristic curve B₀ is a maximum value B₀ₘₐₓ (a maximum value obtained by polynomial expression using measured data). Further, numeral B₁ denotes a measured amplitude characteristic curve of a signal outputted from the reproduction signal processor 10 based on reflected light from the 3T mark in the guide groove of the second recording layer (L1 layer); F_{B1} denotes a focus offset when the measured amplitude characteristic curve B₁ is a maximum value B₁ₘₐₓ (a maximum value obtained by polynomial expression using measured data).

Further, in FIG. 4, numeral Q₀ denotes a position of a focus offset calculated and set by the focus offset calculation-setting unit 322 based on the above-described focus offsets (optimum focus offsets) F_{A0} and F_{A1} using the above-described expression 2 such that the difference between the focus offset and the focus offset F_{A0} is a value corresponding to the characteristic of the optical system 5 i.e. a position of a focus offset weighted to the focus offset F_{A0} side in correspondence with the characteristic of the optical system 5; and F_{Q0} denotes a focus offset corresponding to the position Q₀. Further, numeral Q₁ denotes a position of a focus offset calculated and set by the focus offset calculation-setting unit 322 based on the above-described learned focus offsets F_{A0} and F_{A1} using the above-described expression 3 such that the difference between the focus offset and the focus offset F_{A1} is a value corresponding to the characteristic of the optical system 5 i.e. a position of a focus offset weighted to the focus offset F_{A1} side in correspondence with the characteristic of the optical system 5; and F_{Q1}, a focus offset corresponding to the position Q₁. Further, numeral Q_{C} denotes a position of a focus offset calculated and set by the focus offset calculation setting unit 322 based on the above-described learned focus offsets F_{A0} and F_{A1} using the above-described expression 1 mean value focus offset of the both focus offsets F_{A0} and F_{A1}; and F_{QC} denotes a focus offset corresponding to the position Q_{C}.

Note that in FIG. 4, on the horizontal axis, the position of the focus offset F=0 in the first recording layer (L0 layer) and the position of the focus offset F=0 in the second recording layer (L1 layer) are overlapped each other. That is, the above-described both positions are overlapped each other assuming that the distance h in FIG. 2 is 0 (zero).

More particularly, in FIG. 4, the optimum focus offset F_{A0} for the first recording layer (L0 layer) learned by the focus offset learning unit 321 is about 7×0.05 μm, and the optimum focus offset F_{A1} for the second recording layer (L1 layer), about 0×0.05 μm. Further, the focus offset F_{B0} when the measured amplitude characteristic curve B₀ is the maximum value B₀ₘₐₓ is about 3×0.05 μm, and the focus offset F_{B1} when the measured amplitude characteristic curve B₁ is the maximum value B₁ₘₐₓ, about 2×0.05 μm. Further, the focus offset F_{Q0}, calculated and set by the focus offset calculation-setting unit 322 based on the above-described learned optimum focus offsets F_{A0} and F_{A1} and in correspondence with the characteristic of the optical system 5 as a focus offset for recording or reproduction in the first recording layer (L0 layer), is about 5×0.05 μm; the focus offset F_{Q1} calculated and set as a focus offset for recording or reproduction in the second recording layer (L1 layer) is about 2×0.05 μm; and the focus offset F_{QC}, calculated and set as a mean value of the both focus offsets F_{A0} and F_{A1} as a focus offset for recording or reproduction common to the first recording layer (L0 layer) and the second recording layer (L1 layer), is about 3.5×0.05 μm.

As it is apparent from the above description, the focus offset F_{Q0} (about 5×0.05 μm) set as a focus offset for recording or reproduction in the first recording layer (L0 layer) is a value close to the focus offset F_{B0} (about 3×0.05 μm) when the measured amplitude characteristic curve B₀ of the first recording layer (L0 layer) is the maximum value B₀ₘₐₓ. Further, the focus offset F_{Q1} (about 2×0.05 μm) set as a focus offset for recording or reproduction in the second recording layer (L1 layer) corresponds with the focus offset F_{B1} (about 2×0.05 μm) when the measured amplitude characteristic curve B₁ of the second recording layer (L1 layer) is the maximum value B₁ₘₐₓ. Further, the mean value focus offset F_{QC} (about 3.5×0.05 μm) set as a common focus offset for recording or reproduction to the first recording layer (L0 layer) and the second recording layer (L1 layer) is a value close to the above-described measured focus offset F_{B0} (about 3×0.05 μm) and the above-described measured focus offset F_{B1} (about 2×0.05 μm). As a result, in an optical disc where mutually adjacent recording layers respectively have push-pull signal characteristic and signal amplitude characteristic regarding the 3T mark as shown in FIG. 4, it may be arranged in the optical disc apparatus 1 such that as a focus offset for recording or reproduction, the mean value focus offset of the above-described learned optimum focus offsets F_{A0} and F_{A1} common to the first recording layer (L0 layer) and the second recording layer (L1 layer) is calculated and set based on the expression 1. Otherwise, it may be arranged such that focus offsets corresponding to the respective first recording layer (L0 layer) and the second recording layer (L1 layer) are calculated and set using the expressions 2 and 3.

FIG. 5 is a graph explaining the focus offset learning and the focus offset setting for recording or reproduction in the optical disc apparatus 1 in FIG. 1 based on measured data having a push-pull signal amplitude characteristic different from that in FIG. 4, regarding the optical pickup 4, for which mutually adjacent recording layers are different from these in FIG. 4. As in the case of FIG. 4, in FIG. 5, the horizontal axis indicates the focus offset F, and the vertical axis, the push-pull signal amplitude A and the amplitude B regarding the 3T mark. In FIG. 5, the result of learning by the focus offset learning unit 321 using the push-pull signal is used, the focus offset calculation-setting unit 322 calculates a mean value of optimum focus offsets obtained by the learning, and sets the calculated focus offset as a focus offset for information recording or reproduction, or obtains a focus offset when the difference between the focus offset and the optimum focus offset obtained by the above-described learning is a value corresponding to the characteristic of the optical system 5 i.e. a focus offset weighted in correspondence with the characteristic of the optical system 5, by calculation, and sets the obtained focus offset as focus offset for information recording or reproduction.

In FIG. 5, numeral A₀ denotes a measured amplitude characteristic curve of the push-pull signal outputted from the reproduction signal processor 10 based on reflected light from the guide groove of the first recording layer (L0 layer); A₀ₘₐₓ denotes an amplitude value learned by the focus offset learning unit 321 as a maximum value on the amplitude characteristic curve A₀ i.e. a maximum value (a maximum value obtained by polynomial expression using measured data) of the push-pull signal amplitude regarding the first recording layer (L0 layer); and F_{A0} denotes a focus offset learned by the focus offset learning unit 321 as a focus offset when the push-pull signal amplitude is maximum on the measured amplitude characteristic curve A₀ i.e. an optimum focus offset. Further, numeral A₁ denotes a measured amplitude characteristic curve of the push-pull signal outputted from the reproduction signal processor 10 based on reflected light from the guide groove of the second recording layer (L1 layer); A₁ₘₐₓ denotes an amplitude value learned by the focus offset learning unit 321 as a maximum value on the measured amplitude characteristic curve A₁ i.e. a maximum value (a maximum value obtained by polynomial expression using measured data) of the push-pull signal amplitude regarding the second recording layer (L1 layer); and F_{A1} denotes a focus offset learned by the focus offset learning unit 321 as a focus offset when the push-pull signal amplitude is maximum on the measured amplitude characteristic curve A₁ i.e. an optimum focus offset.

Further, in FIG. 5, numeral B₀ denotes a measured amplitude characteristic curve of a signal outputted from the reproduction signal processor 10 based on reflected light from the 3T mark in the guide groove of the first recording layer (L0 layer); and F_{B0} denotes a focus offset when the measured amplitude characteristic curve B₀ is a maximum value B₀ₘₐₓ (a maximum value obtained by polynomial expression using measured data). Further, numeral B₁ denotes a measured amplitude characteristic curve of a signal outputted from the reproduction signal processor 10 based on reflected light from the 3T mark in the guide groove of the second recording layer (L1 layer); and F_{B1} denotes a focus offset when the measured amplitude characteristic curve B₁ is a maximum value B₁ₘₐₓ (a maximum value obtained by polynomial expression using measured data).

Further, in FIG. 5, numeral Q₀ denotes a position of a focus offset calculated and set by the focus offset calculation-setting unit 322 based on the above-described focus offsets (optimum focus offsets) F_{A0} and F_{A1} using the above-described expression 2 such that the difference between the focus offset and the focus offset F_{A0} is a value corresponding to the characteristic of the optical system 5, i.e., a position of a focus offset weighted to the focus offset F_{A0} side in correspondence with the characteristic of the optical system 5; and F_{Q0} denotes a focus offset corresponding to the position Q₀. Further, numeral Q₁ denotes a position of a focus offset calculated and set by the focus offset calculation-setting unit 322 based on the above-described focus offsets F_{A0} and F_{A1} using the above-described expression 3 such that the difference between the focus offset and the focus offset F_{A1} is a value corresponding to the characteristic of the optical system 5, i.e., a position of a focus offset weighted to the focus offset F_{A1} side in correspondence with the characteristic of the optical system 5; and F_{Q1} denotes a focus offset corresponding to the position Q₁. Further, numeral Q_{C} denotes a position of a focus offset calculated and set by the focus offset calculation setting unit 322 based on the above-described focus offsets F_{A0} and F_{A1} using the above-described expression 1 as a mean value focus offset of the both focus offsets F_{A0} and F_{A1}; and F_{QC} denotes a focus offset corresponding to the position Q_{C}.

Note that in FIG. 5, as in the case of FIG. 4, on the horizontal axis, the position of the focus offset F=0 in the first recording layer (L0 layer) and the position of the focus offset F=0 in the second recording layer (L1 layer) are overlapped each other. That is, in FIG. 5, the above-described both positions are overlapped each other assuming that the distance h in FIG. 2 is 0 (zero).

More particularly, in FIG. 5, the optimum focus offset F_{A0} for the first recording layer (L0 layer) learned by the focus offset learning unit 321 is about 3×0.05 μm, and the optimum focus offset F_{A1} for the second recording layer (L1 layer), about −8×0.05 μm. Further, the focus offset F_{B0} when the measured amplitude characteristic curve B₀ is the maximum value B₀ₘₐₓ is about 0×0.05 μm, and the focus offset F_{B1} when the measured amplitude characteristic curve B₁ is the maximum value B₁ₘₐₓ about −4×0.05 μm. Further, the focus offset F_{Q0}, calculated and set by the focus offset calculation-setting unit 322 based on the above-described learned optimum focus offsets F_{A0} and F_{A1} and in correspondence with the characteristic of the optical system 5 as a focus offset for recording or reproduction in the first recording layer (L0 layer), is about 0×0.05 μm; the focus offset F_{Q1} calculated and set as a focus offset for recording or reproduction in the second recording layer (L1 layer) is about −5×0.05 μm; and the focus offset F_{QC}, calculated and set as a mean value of the both focus offsets F_{A0} and F_{A1} as a focus offset for recording or reproduction common to the first recording layer (L0 layer) and the second recording layer (L1 layer), is about −2.5×0.05 μm.

As it is apparent from the above description, the focus offset F_{Q0} (about 0×0.05 μm) set as a focus offset for recording or reproduction in the first recording layer (L0 layer) approximately corresponds with the focus offset F_{B0} (about 0×0.05 μm ) when the measured amplitude characteristic curve B₀ of the first recording layer (L0 layer) is the maximum value B₀ₘₐₓ. Further, the focus offset F_{Q1} (about −5×0.05 μm) set as a focus offset for recording or reproduction in the second recording layer (L1 layer) is a value close to the focus offset F_{B1} (about −4×0.05 μm) when the measured amplitude characteristic curve B₁ of the second recording layer (L1 layer) is the maximum value B₁ₘₐₓ. However, the difference between the mean value focus offset F_{QC} (about −2.5×0.05 μm), set as a common focus offset for recording or reproduction to the first recording layer (L0 layer) and the second recording layer (L1 layer), and the above-described measured focus offset F_{B0} (about 0×0.05 μm) and the above-described measured focus offset F_{B1} (about −4×0.05 μm) is large. As a result, in an optical disc where mutually adjacent recording layers respectively have push-pull signal characteristic and signal amplitude characteristic regarding the 3T mark as shown in FIG. 5, in the optical disc apparatus 1, appropriate focus offset processing can be performed by calculating and setting a focus offset for recording or reproduction respectively for the first recording layer (L0 layer) and the second recording layer (L1 layer) using the expressions 2 and 3.

FIG. 6 is a flowchart showing the operation of the focus offset processing by the optical disc apparatus 1 in FIG. 1 for the first recording layer (L0 layer) and the second recording layer (L1 layer) as the adjacent recording layers in the optical disc 2. As in the case of FIGS. 4 and 5, in the focus offset processing, the focus offset learning unit 321 learns an optimum focus offset using the push-pull signal.

Upon focus offset processing by the optical disc apparatus 1 with respect to the optical disc 2 having plural recording layers, when a and c are connected in FIG. 6,
(1) first, the system controller 30 as a controller controls the optical disc apparatus 1 to a status where the tracking control is off (OFF) and the focus control is on (ON). That is, the system controller 30 controls the focus/tracking controller 14 not to output the tracking control signal but output only the focus control signal (step S601).
(2) Then a laser beam is emitted from the optical system 5 to the first recording layer (L0 layer) of the mutually adjacent recording layers in the optical disc 2, and the focus offset learning unit 321 as a part of the microcomputer 32 in the system controller 30 learns (detects) focus offset F_{A0} when the amplitude of the push-pull signal outputted from the reproduction signal processor 10 is maximum as an optimum focus offset for the first recording layer (L0 layer) (step S602). The learned optimum focus offset F_{A0} is stored in the memory 40.
(3) Then a laser beam is emitted from the optical system 5 to the second recording layer (L1 layer) of the mutually adjacent recording layers in the optical disc 2, and the focus offset learning unit 321 learns (detects) focus offset F_{A1} when the amplitude of the push-pull signal outputted from the reproduction signal processor 10 is maximum as an optimum focus offset for the second recording layer (L1 layer) (step S603). The learned optimum focus offset F_{A1} is stored in the memory 40.
(4) The focus offset calculation-setting unit 322 as a part of the microcomputer 32 in the system controller 30 calculates and sets focus offset F_{Q0} for information recording or reproduction for the first recording layer (L0 layer) based on the optimum focus offsets F_{A0} and F_{A1} learned by the focus offset learning unit 321 (step S606). The focus offset calculation-setting unit 322 calculates the focus offset F_{Q0} as a focus offset weighted to the focus offset F_{A0} side in correspondence with the characteristic of the optical system 5 using e.g. the expression 2. The set focus offset F_{Q0} is stored in the memory 40.
(5) The focus offset calculation-setting unit 322 calculates and sets focus offset F_{Q1} for recording or reproduction in the second recording layer (L1 layer) based on the learned optimum focus offsets F_{A0} and F_{A1} (step S607). The focus offset calculation-setting unit 322 calculates the focus offset F_{Q1} as a focus offset weighted to the focus offset F_{A1} side in correspondence with the characteristic of the optical system 5 using e.g. the expression 3. The set focus offset F_{Q1} is stored in the memory 40.
(6) The system controller 30 controls the optical disc apparatus 1 to start the recording or reproduction operation with respect to the optical disc 2 using the above-described set focus offsets F_{Q0} and F_{Q1} (step S608). The optical disc apparatus 1 performs recording or reproduction in the first recording layer (L0 layer) using the set focus offset F_{Q0}, and performs recording or reproduction in the second recording layer (L1 layer) using the set focus offset F_{Q1}.

Note that in the above-described focus offset learning and the focus offset calculation and setting, the processing for the first recording layer (L0) is performed prior to the processing for the second recording layer (L1), however, the processing for the second recording layer (L1 layer) may be performed first.

The above-described focus offset processing with respect to the optical disc 2 is performed by execution of the above-described series of operation procedures by the focus offset learning unit 321 and the focus offset calculation-setting unit 322 in accordance with the program stored in the memory.

Further, upon focus offset processing with respect to the optical disc 2 having plural recording layers by the optical disc apparatus 1, when a and b are connected in FIG. 6,
(1) first, the system controller 30 as a controller controls the optical disc apparatus 1 to a status where the tracking control is off (OFF) and the focus control is on (ON). That is, the system controller 30 controls the focus/tracking controller 14 not to output the tracking control signal but output only the focus control signal (step S601).
(2) Then a laser beam is emitted from the optical system 5 to the first recording layer (L0 layer) of the mutually adjacent recording layers in the optical disc 2, and the focus offset learning unit 321 as a part of the microcomputer 32 in the system controller 30 learns (detects) focus offset F_{A0} when the amplitude of the push-pull signal outputted from the reproduction signal processor 10 is maximum as an optimum focus offset for the first recording layer (L0 layer) (step S602). The learned optimum focus offset F_{A0} is stored in the memory 40.
(3) Then a laser beam is emitted from the optical system 5 to the second recording layer (L1 layer) of the mutually adjacent recording layers in the optical disc 2, and the focus offset learning unit 321 learns (detects) focus offset F_{A1} when the amplitude of the push-pull signal outputted from the reproduction signal processor 10 is maximum as an optimum focus offset for the second recording layer (L1 layer) (step S603). The learned optimum focus offset F_{A1} is stored in the memory 40.
(4) The focus offset calculation-setting unit 322 as a part of the microcomputer 32 in the system controller 30 calculates and sets focus offset F_{QC} common to the first recording layer (L0 layer) and the second recording layer (L1 layer) based on the optimum focus offsets F_{A0} and F_{A1} learned by the focus offset learning unit 321, as a focus offset for recording or reproduction (step S604). The focus offset calculation-setting unit 322 calculates the focus offset F_{QC} as a mean value of the both focus offsets F_{A0} and F_{A1} using e.g. the expression 1. The set focus offset F_{QC} is stored in the memory 40.
(5) The system controller 30 controls the optical disc apparatus 1 to start the recording or reproduction operation with respect to the optical disc 2 using the above-described set focus offset F_{QC} (step S605). The optical disc apparatus 1 performs recording or reproduction in the first recording layer (L0 layer) using the focus offset F_{QC}, and performs recording or reproduction in the second recording layer (L1 layer) using the set focus offset F_{QC}.

Note that in the above-described focus offset learning, the learning for the first recording layer (L0 layer) is performed prior to the learning for the second recording layer (L1 layer), however, the learning for the second recording layer (L1 layer) may be performed first.

The above-described focus offset processing with respect to the optical disc 2 is performed by execution of the above-described series of operation procedures by the focus offset learning unit 321 and the focus offset calculation-setting unit 322 in accordance with the program stored in the memory 40.

According to the optical disc apparatus 1 in the embodiment, since a focus offset for recording or reproduction in mutually adjacent recording layers can be calculated and set directly from the result of learning of a maximum amplitude of a push-pull signal or a wobble signal, the time for the focus offset processing for the plural recording layers of the optical disc 2 can be shortened. Further, the recording or reproduction operation can be started in short time. Further, since the focus offset learning is performed utilizing groove information of the guide groove in a recording surface such as push-pull signal or wobble signal, the focus offset learning can be performed even for a recorded-state recording layer (including a reproduction-only disc) and an unrecorded-state recording layer. This improves the precision of the focus offset processing.

Note that in the above-described embodiment, when the focus offset calculation-setting unit 322 calculates and sets a focus offset common to the mutually adjacent first recording layer (L0 layer) and second recording layer (L1 layer) in the optical disc 2 as a focus offset for recording or reproduction, the focus offset calculation-setting unit 322 calculates and sets a mean value (F_{A0}+F_{A1})/2 of the focus offsets F_{A0} and F_{A1} learned by the focus offset learning unit 321 using the expression 1. Further, it may be arranged such that, in correspondence with the characteristic of the optical system 5, a common focus offset other than the mean value, from which the differences between the focus offset and the respective optimum focus offsets F_{A0} and F_{A1} are different, is calculated and set by (m×F_{A0}+n×F_{A1})/(m+n). Note that m and n are coefficients determined in correspondence with the characteristic of the optical system 5.

According to the optical disc, the focus offset processing for plural recording layers can be performed in a short time, and the information recording or reproduction operation can be quickly started. Further, even for a recorded-state recording layer (including a reproduction-only disc) and an unrecorded-state recording layer, the precision of the focus offset processing can be ensured.

The present invention can be implemented in other examples than the above-described embodiment within the spirit and subject matter of the present invention. Accordingly, it is to be understood that the above-described embodiment is merely an example of the present invention in all respects and is not to be limitedly interpreted. The scope of the present invention is defined in the claims. Further, all the modifications and changes in the equivalent scope of the claims are included within the scope of the present invention.

What is claimed is:

1. An optical disc apparatus capable of information recording or reproduction with respect to an optical disc having a plurality of recording layers, comprising:
an optical system that collects a laser beam and emits the laser beam on the recording layer; and
a controller that learns a focus offset of the optical system to a guide groove, formed in a recording surface of the recording layer, from a signal based on reflected light from the guide groove, for the respective mutually adjacent recording layers, and calculates and sets a focus offset of the optical system for recording or reproduction based on the learned focus offsets for the respective recording layers.

2. An optical disc apparatus capable of information recording or reproduction with respect to an optical disc having a plurality of recording layers, comprising:
an optical system that collects a laser beam and emits the laser beam on the recording layer;
a first controller that learns a focus offset of the optical system to a guide groove, formed in a recording surface of the recording layer, from a signal based on reflected light from the guide groove, for the respective mutually adjacent recording layers; and
a second controller that calculates and sets a focus offset of the optical system for recording or reproduction based on the focus offsets for the respective recording layers learned by the first controller.

3. The optical disc apparatus according to claim 2, wherein the first controller uses a push-pull signal or a wobble signal as the signal based on the reflected light, and learns a focus offset when an amplitude of the push-pull signal or the wobble signal is in a maximum range as focus offsets for the respective guide grooves.

4. The optical disc apparatus according to claim 2, wherein the second controller calculates a mean value of the learned focus offsets for the respective recording layers or a focus offset when differences between the focus offset and the focus offsets for the respective recording layers are different, and sets the calculated focus offset as the focus offset of the optical system for recording or reproduction common to the both recording layers.

5. The optical disc apparatus according to claim 3, wherein the second controller calculates a mean value of the learned focus offsets for the respective recording layers or a focus offset when differences between the focus offset and the focus offsets for the respective recording layers are different, and sets the calculated focus offset as the focus offset of the optical system for recording or reproduction common to the both recording layers.

6. The optical disc apparatus according to claim 2, wherein the second controller calculates a focus offset when a difference between the focus offset and the focus offsets for the respective recording layers learned by the first controller is a value corresponding to a characteristic of the optical system, and sets the calculated focus offset as the focus offset of the optical system for recording or reproduction for the respective recording layers.

7. The optical disc apparatus according to claim 3, wherein the second controller calculates a focus offset when a difference between the focus offset and the focus offsets for the respective recording layers learned by the first controller is a value corresponding to a characteristic of the optical system, and sets the calculated focus offset as the focus offset of the optical system for recording or reproduction for the respective recording layers.

8. The optical disc apparatus according to claim 6, wherein, assuming that the focus offset for a first recording layer of the adjacent recording layers learned by the first controller is F_{A0}, the focus offset for a second recording layer is F_{A1}, the focus offset set by the second controller as a focus offset for recording or reproduction for the first recording layer is F_{Q0}, and the focus offset set by the second controller as a focus offset for recording or reproduction for the second recording layer is F_{Q1}, the second controller calculates the focus offsets F_{Q0} and F_{Q1} by
F_{Q0}=(3×F_{A0}+F_{A1})/4
F_{Q1}=(F_{A0}+3×F_{A1})/4.

9. The optical disc apparatus according to claim 7, wherein, assuming that the focus offset for a first recording layer of the adjacent recording layers learned by the first controller is F_{A0}, the focus offset for a second recording layer is F_{A1}, the focus offset set by the second controller as a focus offset for recording or reproduction for the first recording layer is F_{Q0}, and the focus offset set by the second controller as a focus offset for recording or reproduction for the second recording layer is F_{Q1}, the second controller calculates the focus offsets F_{Q0} and F_{Q1} by
F_{Q0}=(3×F_{A0}+F_{A1})/4
F_{Q1}=(F_{A0}+3×F_{A1})/4.

10. A focus offset setting method for an optical disc apparatus capable of information recording or reproduction by collecting a laser beam and emitting the laser beam by an optical system with respect to an optical disc having a plurality of recording layers, comprising:
a first step of learning a focus offset of the optical system to a guide groove, formed in a recording surface of the recording layer, from a signal based on reflected light from the guide groove, for the respective mutually adjacent recording layers; and
a second step of calculating and setting a focus offset of the optical system for recording or reproduction based on the learned respective focus offsets.

11. The focus offset setting method for the optical disc apparatus according to claim 10, wherein, at the second step, a mean value of the focus offsets for the respective recording layers learned at the first step is calculated, and the mean value is set as a focus offset for recording or reproduction common to the both recording layers.

12. The focus offset setting method for the optical disc apparatus according to claim 10, wherein, at the second step, a focus offset when a difference between the focus offset and the focus offsets for the respective recording layers learned at the first step is a value corresponding to a characteristic of the optical system is calculated, and the calculated focus offset is set as a focus offset of the optical system for recording or reproduction for the respective recording layers.
